(19) United States
(12) Patent Application Publication
(10) Pub. No.: US 2006/0241277 A1
(43) Pub. Date: Oct. 26, 2006

(54) Method for preparing imide substituted copolymer resin

(76) Inventors: Moon-kyoon Chun, Yeosu-si (KR); Tae-hoon Kim, Gangseo-gu (KR); Chan-hong Lee, Yuseong-gu (KR); Jae-il Roh, Jeonju-si (KR)

Correspondence Address: CANTOR COLBURN, LLP, 55 GRIFFIN ROAD SOUTH, BLOOMFIELD, CT, 06002, US

(21) Appl. No.: 11/324,953

(22) Filed: Jan. 4, 2006

(30) Foreign Application Priority Data
Apr. 20, 2005 (KR) 10-2005-0032635

(51) Int. Cl. C08G 73/00

(52) U.S. Cl. 528/170

(57) ABSTRACT

The present invention relates to a method for preparing an imide substituted copolymer resin comprising the steps of: copolymerization by feeding a mixture of an aromatic vinyl monomer and a vinyl cyanide monomer, a mixture of an unsaturated dicarboxylic anhydride monomer and a solvent, an initiator and a chain transfer agent at once to a copolymerization reactor; and imide substitution by continuously feeding the resultant polymerization solution to an imide substitution reactor while continuously feeding a primary amine. The preparation method according to the present invention is capable of continuously preparing an imide substituted copolymer resin having superior heat resistance and excellent fluidity and improving mechanical property and compatibility with ABS resin by inhibiting formation of aromatic vinyl homopolymer.

### CROSS-REFERENCE TO RELATED APPLICATIONS

This application claims the benefit of Korean Patent Application No. 10-2005-0032635, filed on Apr. 20, 2005, in the Korean Intellectual Property Office, the disclosure of which is incorporated herein by reference.

### BACKGROUND OF THE INVENTION

1. Field of the Invention

The present invention relates to a method for preparing an imide substituted copolymer resin comprising the steps of: copolymerization by feeding a mixture of an aromatic vinyl monomer and a vinyl cyanide monomer, a mixture of an unsaturated dicarboxylic anhydride monomer and a solvent, an initiator and a chain transfer agent at once to a copolymerization reactor; and imide substitution by continuously feeding the resultant polymerization solution to an imide substitution reactor while continuously feeding a primary amine.

2. Description of Related Art

The present invention relates to a method for preparing an imide substituted copolymer resin, more particularly to a method for preparing an imide substituted copolymer resin having superior heat resistance and fluidity and improved mechanical property and compatibility with ABS resin.

Heat-resistant acrylonitrile-butadiene-styrene (ABS) resin is used in a variety of applications, including office instruments, home appliances, electric-electronic devices and interior/exterior goods for automobiles, because of superior impact resistance, processing property, chemical resistance, surface gloss, etc. Demand on high-functional, heat-resistant resin having better heat resistance is increasing.

Typically, styrene-acrylonitrile (SAN) resin, which is used as base resin of the ABS resin, has superior chemical resistance, mechanical property, transparency, etc. and has very superior compatibility with grafted rubber particles. So, SAN resin is used in a variety of fields. However, since it has insufficient heat resistance, it is not adequate for used at high temperature. Thus, a resin having such a good heat resistance as to be used in heat-resistant ABS resin is required.

There are several ways of providing heat resistance to the ABS resin. One of them is a method of increasing a heat resistance of the base resin of ABS, called, a heat-resistant resin. A heat-resistant resin may be prepared, for example, by copolymerizing an unsaturated dicarboxylic anhydride with styrene. Typically, maleic anhydride is used as the unsaturated dicarboxylic anhydride. The resultant copolymer, a typical alternating copolymer, has good heat resistance. However, it has poor weather resistance because of the anhydride group and is pyrolyzed at high temperatures, thereby producing gas.

Of recent, a heat-resistant resin in which a thermally stable cyclic imide is introduced is gaining focus. For example, a heat-resistant styrene-maleimide copolymer can be produced by directly copolymerizing styrene with maleimide.

However, a more economical way of producing the styrene-maleimide copolymer is to substitute maleic anhydride of the main chain of a styrene-maleic anhydride copolymer with maleimide using a primary amine.

Japanese Patent Laid-Open No. Sho 58-11514 attempted to prepare a copolymer having a uniform composition by varying proportion of styrene and maleic anhydride depending on the polymerization rate. However, with this method, it is difficult to obtain a copolymer having a uniform composition and to attain a polymerization rate of 90% or above. Also, a lot of time is required for polymerization of the styrene-maleimide copolymer.

Japanese Patent Laid-Open Nos. Sho 58-180506, Hei 2-4806, Hei 6-56921 and Hei 9-100322 disclosed continuous imide substitution methods of reacting a styrene-maleic anhydride copolymer in melt state with a primary amine by the reactive extrusion. However, these methods do not give a uniform copolymer composition, and consequently, the thermal stability of the resultant maleimide copolymer is insufficient. Moreover, discoloration tends to occur due to remaining amines because of the low imide substitution ratio. In addition, since the amine has to be used in 2-3 equivalents per maleic anhydride, a complex process of separating and removing the unreacted amine is necessary, because the remaining amine greatly impairs physical properties of the resin.

Japanese Patent Laid-Open No. 2001-329021 disclosed a continuous preparation method of an imidized copolymer. However, this method is uneconomical because a very long polymerization time, i.e., at least 15 hours for copolymerization of styrene and maleic anhydride and at least 9 hours for imide substitution, is required. Also, the multi-step polymerization is rather complex.

### SUMMARY OF THE INVENTION

The present invention was made to solve these problems and it is an object of the invention to provide a method for preparing an imide substituted copolymer resin having superior heat resistance and excellent fluidity.

It is another object of the invention to provide a method for preparing an imide substituted copolymer resin capable of greatly improving mechanical property and compatibility with ABS resin by inhibiting production of an aromatic vinyl homopolymer.

### DETAILED DESCRIPTION OF THE INVENTION

To attain the objects, the present invention provides a method for preparing an imide substituted copolymer resin comprising the steps of:

a) performing the copolymerization after adding a mixture of an aromatic vinyl monomer and a vinyl cyanide monomer, a mixture of an unsaturated dicarboxylic anhydride monomer and a solvent, an initiator and a chain transfer agent to a copolymerization reactor at once; and

b) performing the imide substitution by feeding the polymerization solution of the step a) to an imide substitution reactor and continuously adding a primary amine.

Hereunder is given a more detailed description of the present invention.

In the copolymerization step a), a mixture of an aromatic vinyl monomer and a vinyl cyanide monomer and a mixture of an unsaturated dicarboxylic anhydride monomer and a solvent are added to a copolymerization reactor at once, at a rate controlled corresponding to the composition of each mixture, respectively. An initiator and a chain transfer agent are also added to copolymerize the aromatic vinyl monomer, the vinyl cyanide monomer and the unsaturated dicarboxylic anhydride monomer.

In the imide substitution step b), the polymerization solution obtained from the copolymerization step is fed to an imide substitution reactor connected with the copolymerization reactor and a primary amine is added continuously to substitute the dicarboxylic acid anhydride group of the copolymer.

Then, the polymerization solution that has passed through the imide substitution step is continuously fed into a devolatilizer to remove low-molecular-weight evaporable components (i.e., unreacted monomers, solvent, etc.).

As a result, an imide substituted copolymer resin comprising 45-56 wt % of an aromatic vinyl monomer, 2-10 wt % of a vinyl cyanide monomer, 35-45 wt % of a maleimide monomer and 0-5 wt % of an unsaturated dicarboxylic anhydride monomer is obtained.

Hereunder is given a more detailed description of the method for preparing an imide substituted copolymer resin of the present invention.

[Step 1]

(Copolymerization of Aromatic Vinyl Monomer, Vinyl Cyanide Monomer and Unsaturated Dicarboxylic Anhydride Monomer)

In this step, an aromatic vinyl monomer, a vinyl cyanide monomer and an unsaturated dicarboxylic anhydride monomer are copolymerized. A mixture of an aromatic vinyl monomer and a vinyl cyanide monomer and a mixture of an unsaturated dicarboxylic anhydride monomer and a solvent are added to a copolymerization reactor at once, at a rate controlled corresponding to the composition of each mixture, respectively. An initiator and a chain transfer agent are also added to copolymerize the monomers.

Since the aromatic vinyl monomer and the unsaturated dicarboxylic anhydride monomer copolymerize at room temperature, they should be kept in separate tanks and are preferably fed at once to the copolymerization reactor. The separation of the source materials can be used by the conventional method and preferably, they are grouped into a mixture of the aromatic vinyl monomer and the vinyl cyanide monomer and a mixture of the unsaturated dicarboxylic anhydride monomer and the solvent.

The aromatic vinyl monomer includes styrene monomers such as styrene, α-methylstyrene, vinyltoluene, t-butylstyrene, chlorostyrene, and substituted monomers thereof and mixtures thereof. Particularly, styrene is preferable.

Preferably, the aromatic vinyl monomer is used in 20-60 wt %, more preferably in 25-50 wt %, per 100 wt % of the mixture of the aromatic vinyl monomer and the vinyl cyanide monomer plus the mixture of the unsaturated dicarboxylic anhydride monomer and the solvent. If the content is below 20 wt %, the sufficient polymerization yield cannot be attained. Otherwise, if it exceeds 60 wt %, the resultant resin does not have sufficient heat resistance.

The vinyl cyanide monomer includes acrylonitrile, methacrylonitrile, chloroacrylonitrile and substituted monomers thereof and mixtures thereof. Particularly, acrylonitrile is preferable.

Preferably, the vinyl cyanide monomer is used in 1-10 wt %, more preferably in 2-7 wt %, per 100 wt % of the mixture of the aromatic vinyl monomer and the vinyl cyanide monomer plus the mixture of the unsaturated dicarboxylic anhydride monomer and the solvent. If the content is below 1 wt %, the compatibility with ABS tends to be insufficient. Otherwise, if it exceeds 10 wt %, the resultant resin does not have the sufficient heat resistance.

In the present invention, an aromatic vinyl-vinyl cyanide copolymer is prepared from the addition of the vinyl cyanide monomer, thereby inhibiting production of an aromatic vinyl homopolymer, which reduces the mechanical property and compatibility with ABS. The resultant imide substituted copolymer resin has the significantly improved mechanical property (especially, impact strength) and compatibility with ABS resin.

For the initiator, the organic peroxide having at least two functional groups can be used.

The organic peroxide may be 1,1-di(t-butylperoxy)3,3,5-trimethylcyclohexane, 1,1-di(t-butylperoxy)cyclohexane, 2,2-bis(t-butylperoxy)butane, 2,2,4-trimethylpentyl-2-hydroperoxide, 2,5-dimethyl-2,5-bis(t-butylperoxy)hexane, 2,5-dimethyl-2,5-di(benzoylperoxy)hexane, 1,1-di(t-amylperoxy)cyclohexane, 2,2-bis(4,4-di-t-butylperoxycyclohexyl)propane, ethyl-3,3-di(t-amylperoxy)butyrate, ethyl-3,3-di(t-butylperoxy)butyrate, 1,1-bis(t-butylperoxy)-3,3,5-trimethylcyclohexane or t-butylperoxy-3,5,5-trimethylhexanoate.

Preferably, the initiator is used in 0.01-0.1 wt % per 100 wt % of the mixture of the aromatic vinyl monomer and the vinyl cyanide monomer plus the mixture of the unsaturated dicarboxylic anhydride monomer and the solvent. If the content is below 0.01 wt %, the polymerization rate decreases. Otherwise, if it exceeds 0.1 wt %, the molecular weight decreases greatly, and it is difficult to control the reaction heat.

For controlling the molecular weight of the resin, a conventional chain transfer agent may be used. To be specific, t-dodecylmercaptan, n-octylmercaptan, α-methylstyrene dimer, etc. may be used.

Preferably, the chain transfer agent is used in 0.01-0.5 wt % per 100 wt % of the mixture of the aromatic vinyl monomer and the vinyl cyanide monomer plus the mixture of the unsaturated dicarboxylic anhydride monomer and the solvent. If the content is below 0.01 wt %, the molecular weight control becomes difficult. Otherwise, if it exceeds 0.5 wt %, the molecular weight decreases significantly, so that physical properties worsen.

For the unsaturated dicarboxylic anhydride monomer, maleic anhydride, citraconic anhydride, dimethylmaleic anhydride or phenylmaleic anhydride, etc. may be used. Particularly, maleic anhydride is preferable.

Preferably, the unsaturated dicarboxylic anhydride monomer is used in 5-25 wt % per 100 wt % of the mixture of the aromatic vinyl monomer and the vinyl cyanide monomer plus the mixture of the unsaturated dicarboxylic anhydride monomer and the solvent. If the content is below 5 wt %, the sufficient heat resistance cannot be attained. Otherwise, if it exceeds 25 wt %, the preparation process becomes very complicated.

The solvent includes ketones such as methyl ethyl ketone, cyclohexanone, methyl isobutyl ketone, acetone, etc. Particularly, cyclohexanone is preferable.

Preferably, the solvent is used in 30-60 wt %, more preferably in 35-55 wt %, per 100 wt % of the mixture of the aromatic vinyl monomer and the vinyl cyanide monomer plus the mixture of the unsaturated dicarboxylic anhydride monomer and the solvent. If the content is below 30 wt %, the viscosity of the polymer mixture overly rises during the copolymerization and the control of reaction heat becomes difficult. Otherwise, if it exceeds 60 wt %, the molecular weight of the resin decreases and the polymerization productivity reduces significantly.

In the copolymerization step, the source materials are fed into a single reactor. The copolymerization reactor may be a continuous stirred tank reactor, a plug-flow reactor or a multi-stage reactor. Particularly, a continuous stirred tank reactor is preferable. In the examples to be described below, a full-charged continuous stirred tank reactor, where source materials are fed from the bottom of the reactor and the polymerization solution is discharged from the top, was used.

Preferably, the copolymerization is performed at a temperature range of 90-140° C., more preferably 100-130° C. If the polymerization temperature is below 90° C., the desired polymerization rate cannot be attained. Otherwise, if it exceeds 140° C., the desired molecular weight cannot be obtained.

During the copolymerization step, the residence time of the polymerization solution in the reactor is ranged preferably for 2-6 hours, more preferably for 3-5 hours. If the residence time is shorter than 2 hours, the sufficient polymerization rate cannot be attained, so that the heat resistance decreases significantly. Otherwise, if it exceeds 6 hours, the polymerization efficiency decreases significantly.

From the copolymerization step, an aromatic vinyl-vinyl cyanide-unsaturated dicarboxylic anhydride terpolymer resin is obtained. Hereunder, the said terpolymer resin is simply put as the copolymer resin.

[Step 2]

(Imide Substitution Step)

In this step, a primary amine is continuously fed to the polymerization solution that has passed through the copolymerization step in an imide substitution reactor in order to significantly improve heat resistance and thermal stability of the copolymer resin. Here, imide substitution refers only to substitution of the unsaturated dicarboxylic anhydride units in the copolymer resin with the primary amine.

The primary amine may be methylamine, ethylamine, propylamine, butylamine, hexylamine, cyclohexylamine, decylamine, aniline, toluidine, chlorophenylamine, bromophenylamine, etc. Particularly, aniline is preferable.

Since the primary amine reacts with the unsaturated dicarboxylic acid anhydride in 1:1 molar ratio, amount of the primary amine to be added depends on the amount of the unsaturated dicarboxylic acid anhydride. Preferably, 0.5-1.5 moles of the primary amine is used per 1 mole of the unsaturated dicarboxylic acid anhydride comprised in the copolymer resin. If its content is below 0.5 moles, the unsaturated dicarboxylic acid anhydride unsubstituted may greatly impair the thermal stability and processing property of the resin. Otherwise, if it exceeds 1.5 moles, the excessive primary amine unreacted in the resin causes the discoloration and poor physical property.

The imide substitution is performed in a single reactor. The reactor may be a continuous stirred tank reactor, a plug-flow reactor or a multi-stage reactor. In the examples to be described below, a full-charged continuous stirred tank reactor, where source materials are fed from the bottom of the reactor and the polymerization solution is discharged from the top, was used.

Preferably, the imide substitution is performed at a temperature range of 130-180° C., more preferably 140-170° C. If the reaction temperature is below 130° C., the desired conversion of imide substitution cannot be attained. Otherwise, if it exceeds 180° C., the decomposition of the primary amine may occur.

Residence time inside the reactor during the imide substitution step is preferably 1.5-4 hours, more preferably for 2-3 hours. If the residence time is shorter than 1.5 hour, the sufficient imide substitution rate cannot be attained, so that the heat resistance and thermal stability become very poor. Otherwise, if it exceeds 4 hours, the production of byproducts undesirable increases largely, which impair physical properties.

In the imide substitution step, the conversion of the primary amine, or the imide substitution yield, is preferably at least 75 mol %, more preferably at least 85 mol %, and most preferably at least 90 mol %. If the conversion of the primary amine is below 75 mol %, the thermal stability of the imide substituted copolymer resin is very poor.

[Step 3]

(Devolatilization Step)

In the last step, the polymerization solution that has passed through the imide substitution step is continuously fed to a devolatilizer to remove low-molecular-weight evaporable components (i.e., unreacted monomers, solvent, etc.) and obtain an imide substituted copolymer resin.

During the devolatilization step, the temperature and pressure inside the devolatilizer are preferably kept at 200-350° C. and 10-100 torr, more preferably at 230-320° C. and 10-70 torr, respectively.

The resultant imide substituted copolymer resin of the present invention has superior heat resistance with a glass transition temperature (T_{g}) of 175-195° C. Also, with a→the good imide substitution efficiency (imide substitution yield of the unsaturated dicarboxylic acid anhydride being at least 95 wt %), the imide substituted copolymer resin has superior thermal stability, weather resistance and mechanical property.

### EXAMPLES

Hereinafter, the present invention is described in further detail through examples. However, the following examples are only for the understanding of the invention and the invention is not limited to or by them.

### Example 1

A styrene source mixture solution (styrene/acrylonitrile=87.5/12.5, based on weight) and a maleic anhydride source mixture solution (maleic anhydride/cyclohexanone=21.4/78.6, based on weight) were simultaneously fed to a first reactor (copolymerization reactor) having an inner volume of 42 L, at a flow rate of 3.64 kg/hr and 6.36 kg/hr, respectively. Polymerization was performed at 120° C. while continuously adding 250 ppm of 1,1-bis(t-butylperoxy)-3,3,5-trimethylcyclohexane, an initiator, and 250 ppm of α-methylstyrene dimer, a chain transfer agent, based on the total weight of the styrene source mixture solution and the maleic anhydride source mixture solution, to the first reactor.

The polymerization solution discharged from the first reactor was fed to a second reactor (imide substitution reactor) having an inner volume of 32 L. Imide substitution was performed at 150° C. while continuously adding aniline at a flow rate of 1.30 kg/hr.

The resultant product was put in an devolatilizer kept at a temperature of 250° C. and a pressure of 20 torr. Evaporable components were sufficiently removed for 30 minutes.

Sample was taken from the resultant product to measure polymerization conversion and imide substitution yield of each monomer. Composition, molecular weight and glass transition temperature of the resultant imide substituted copolymer resin are given in Table 1.

### Example 2

A styrene source mixture solution (styrene/acrylonitrile=88.2/11.8, based on weight) and a maleic anhydride source mixture solution (maleic anhydride/cyclohexanone=18.5/81.5, based on weight) were simultaneously fed to a first reactor (copolymerization reactor) having an inner volume of 42 L, at a flow rate of 3.86 kg/hr and 6.14 kg/hr, respectively. Polymerization was performed at 120° C. while continuously adding 250 ppm of 1,1-bis(t-butylperoxy)-3,3,5-trimethylcyclohexane, an initiator, and 250 ppm of α-methylstyrene dimer, a chain transfer agent, based on the total weight of the styrene source mixture solution and the maleic anhydride source mixture solution, to the first reactor.

The polymerization solution discharged from the first reactor was fed to a second reactor (imide substitution reactor) having an inner volume of 32 L. Imide substitution was performed at 150° C. while continuously adding aniline at a flow rate of 1.08 kg/hr.

The resultant product was put in a devolatilizer kept at a temperature of 250° C. and a pressure of 20 torr. Evaporable components were sufficiently removed for 30 minutes.

Sample was taken from the resultant product to measure polymerization conversion and imide substitution yield of each monomer. Composition, molecular weight and glass transition temperature of the resultant imide substituted copolymer resin are given in Table 1.

### Example 3

A styrene source mixture solution (styrene/acrylonitrile=86.7/13.3, based on weight). and a maleic anhydride source mixture solution (maleic anhydride/cyclohexanone=24.1/75.9, based on weight) were simultaneously fed to a first reactor (copolymerization reactor) having an inner volume of 42 L, at a flow rate of 3.41 kg/hr and 6.59 kg/hr, respectively. Polymerization was performed at 120° C. while continuously adding 250 ppm of 1,1-bis(t-butylperoxy)-3,3,5-trimethylcyclohexane, an initiator, and 250 ppm of α-methylstyrene dimer, a chain transfer agent, based on the total weight of the styrene source mixture solution and the maleic anhydride source mixture solution, to the first reactor.

The polymerization solution discharged from the first reactor was fed to a second reactor (imide substitution reactor) having an inner volume of 32 L. Imide substitution was performed at 150° C. while continuously adding aniline at a flow rate of 1.51 kg/hr.

The resultant product was put in a devolatilizer kept at a temperature of 250° C. and a pressure of 20 torr. Evaporable components were sufficiently removed for 30 minutes.

Sample was taken from the resultant product to measure polymerization conversion and imide substitution yield of each monomer. Composition, molecular weight and glass transition temperature of the resultant imide substituted copolymer resin are given in Table 1.

### Example 4

A styrene source mixture solution (styrene/acrylonitrile=85.7/14.3, based on weight) and a maleic anhydride source mixture solution (maleic anhydride/cyclohexanone=26.7/73.3, based on weight) were simultaneously fed to a first reactor (copolymerization reactor) having an inner volume of 42 L, at a flow rate of 3.18 kg/hr and 6.82 kg/hr, respectively. Polymerization was performed at 120° C. while continuously adding 250 ppm of 1,1-bis(t-butylperoxy)-3,3,5-trimethylcyclohexane, an initiator, and 250 ppm of α-methylstyrene dimer, a chain transfer agent, based on the total weight of the styrene source mixture solution and the maleic anhydride source mixture solution, to the first reactor.

The polymerization solution discharged from the first reactor was fed to a second reactor (imide substitution reactor) having an inner volume of 32 L. Imide substitution was performed at 150° C. while continuously adding aniline at a flow rate of 1.73 kg/hr.

The resultant product was put in a devolatilizer kept at a temperature of 250° C. and a pressure of 20 torr. Evaporable components were sufficiently removed for 30 minutes.

Sample was taken from the resultant product to measure polymerization conversion and imide substitution yield of each monomer. Composition, molecular weight and glass transition temperature of the resultant imide substituted copolymer resin are given in Table 1.

### Comparative Example 1

Styrene and a maleic anhydride source mixture solution (maleic anhydride/cyclohexanone=21.4/78.6, based on weight) were simultaneously fed to a first reactor (copolymerization reactor) having an inner volume of 42 L, at a flow rate of 3.64 kg/hr and 6.36 kg/hr, respectively. Polymerization was performed at 120° C. while continuously adding 250 ppm of 1,1-bis(t-butylperoxy)-3,3,5-trimethylcyclohexane, an initiator, and 250 ppm of α-methylstyrene dimer, a chain transfer agent, based on the total weight of the styrene source mixture solution and the maleic anhydride source mixture solution, to the first reactor.

The polymerization solution discharged from the first reactor was fed to a second reactor (imide substitution reactor) having an inner volume of 32 L. Imide substitution was performed at 150° C. while continuously adding aniline at a flow rate of 1.30 kg/hr.

The resultant product was put in a devolatilizer kept at a temperature of 250° C. and a pressure of 20 torr. Evaporable components were sufficiently removed for 30 minutes.

Sample was taken from the resultant product to measure polymerization conversion and imide substitution yield of each monomer. Composition, molecular weight and glass transition temperature of the resultant imide substituted copolymer resin are given in Table 1.

Polymerization conversion and composition, molecular weight, glass transition temperature and melt flow index of the imide substituted copolymer resin were measured as follows.

a) Polymerization conversion—Sample was taken from the polymerization solution discharged from the second reactor. About 3 equivalents of methanol were added to precipitate the imide substituted copolymer resin. After drying in vacuum, the precipitate was weighed to measure polymerization conversion. Content of unreacted monomer was measured by gas chromatography (GC) in order to correct the polymerization conversion measured by precipitation.

b) Composition of copolymer resin—Each composition of styrene, acrylonitrile and N-phenylmaleimide of the maleimide copolymer was determined by ¹³C-NMR. An adequate amount of sample was homogeneously dissolved in a CDCl₃d solvent and measurement was made with ARX300 (Bruker).

c) Molecular weight—0.2 g of the copolymer resin was dissolved in 20 mL of tetrahydrofuran (THF). The solution was filtered through a 0.45 μm filter and weight-average molecular weight was measured by gel permeation chromatography (GPC, Waters-Maxima 820). Injection time, injection number and column temperature were fixed at 25 minutes, once and 40° C., respectively.

d) Glass transition temperature—Glass transition temperature (T_{g}) was measured by differential scanning calorimetry (DSC, TA Instruments-Q10). Measurement was made while heating and cooling between 30° C. and 250° C. at a rate of 20° C./min once, and then increasing to 250° C. at a rate of 10° C./min, in order to keep thermal history constant.

e) Melt flow index (MFI)—Each copolymer resin of Examples 1-4 and Comparative Example 1 was extruded at 265° C. under a load of 10 kg using a melt indexer (Toyoseiki, F-F01) for 10 minutes, according to ASTM D-1238.

TABLE 1

| | | | | | Comp. |
|---|---|---|---|---|---|
| | Example 1 | Example 2 | Example 3 | Example 4 | Example 1 |
| Polymerization conversion (wt %) | 85.3 | 83.1 | 86.7 | 88.1 | 82.7 |

Imide substituted copolymer resin

| | | | | | | |
|---|---|---|---|---|---|---|
| Composition | Styrene | 53.3 | 57.8 | 50.7 | 47.4 | 53.2 |
| (wt %) | N-Phenylmaleimide | 38.4 | 34.4 | 41.5 | 44.6 | 45.5 |
| | Maleic anhydride | 1.8 | 1.5 | 1.4 | 1.5 | 1.3 |
| | Acrylonitrile | 6.5 | 6.3 | 6.4 | 6.5 | 0 |

| | | | | | |
|---|---|---|---|---|---|
| Molecular weight (M_{w}) | 105,000 | 102,000 | 105,000 | 106,000 | 104,000 |
| Glass transition temperature (° C.) | 176.4 | 172.5 | 178.7 | 181.6 | 179.3 |
| Melt index (g/10 min) | 26.7 | 30.5 | 23.9 | 22.1 | 15.4 |

As seen in Table 1, the copolymer resin of Comparative Example 1 had a lower melt index than those of Examples 1-4, which shows that the imide substituted copolymer resin of the present invention has superior fluidity.

### Testing Example

Each of the imide substituted copolymer resins prepared in Examples 1-4 and Comparative Example 1 was added to ABS resin. Heat deflection temperature and Izod impact strength were measured.

For the ABS resin, a product of the assignee of the invention was used. The imide substituted copolymer resins were used in the same amount. Mixing proportion of the ABS resin to the imide substituted copolymer resin was 70:30 by weight.

Heat deflection temperature was measured for a ¼″ sample under a load of 18.5 kg/cm², according to ASTM D-648. Izod impact strength was measured at 23° C. for a ¼″ ample, according to ASTM D-256. The result is given in Table 2.

TABLE 2
Imide substituted copolymer resin added to ABS resin

| | | | | | Comp. |
|---|---|---|---|---|---|
| | Example 1 | Example 2 | Example 3 | Example 4 | Example 1 |
| Heat | 107.8 | 104.3 | 109.4 | 112.3 | 110.2 |
| deflection | | | | | |
| temperature | | | | | |
| (° C.) | | | | | |
| Izod impact | 23.5 | 25.8 | 22.1 | 20.4 | 17.7 |
| strength | | | | | |
| (kg · cm/cm) | | | | | |

As seen in Table 2, when the imide substituted copolymer resins prepared in Examples 1-4 and Comparative Example 1 were added to ABS resin, heat deflection temperature was proportional to the glass transition temperature, but impact strength was significantly better for Examples 1-4 than Comparative Example 1.

This is because the acrylonitrile, a kind of vinyl cyanide monomer, facilitates formation of SAN, a kind of aromatic vinyl-vinyl cyanide copolymer, so that production of an aromatic vinyl homopolymer, or polystyrene, inhibits which reduces mechanical property and compatibility. Thus, the imide substituted copolymer resin of the present invention has good compatibility with ABS resin.

In accordance with the present invention, an imide substituted copolymer resin having superior heat resistance and excellent fluidity can be prepared continuously. Also, because production of an aromatic vinyl homopolymer is inhibited, the resultant imide substituted copolymer resin has significantly improved mechanical property and compatibility with ABS resin.

While the present invention has been described in detail with reference to the preferred embodiments, those skilled in the art will appreciate that various modifications and substitutions can be made thereto without departing from the spirit and scope of the invention as set forth in the appended claims.

1. A method for preparing an imide substituted copolymer resin comprising the steps of:
a) performing copolymerization after adding a mixture of an aromatic vinyl monomer and a vinyl cyanide monomer, a mixture of an unsaturated dicarboxylic anhydride monomer and a solvent, an initiator and a chain transfer agent to a copolymerization reactor at once; and
b) performing imide substitution by feeding the polymerization solution of the step a) to an imide substitution reactor and continuously adding a primary amine.

2. The method of claim 1, the aromatic vinyl monomer being at least one selected from a group consisting of styrene, α-methylstyrene, vinyltoluene, t-butylstyrene, chlorostyrene, substituted monomers thereof and mixtures thereof.

3. The method of claim 1, the aromatic vinyl monomer being used in 20-60 wt % per 100 wt % of the mixture of the aromatic vinyl monomer and the vinyl cyanide monomer plus the mixture of the unsaturated dicarboxylic anhydride monomer and the solvent.

4. The method of claim 1, the vinyl cyanide monomer being at least one selected from a group consisting of acrylonitrile, methacrylonitrile, chloroacrylonitrile, substituted monomers thereof and mixtures thereof.

5. The method of claim 1, the vinyl cyanide monomer being used in 1-10 wt % per 100 wt % of the mixture of the aromatic vinyl monomer and the vinyl cyanide monomer plus the mixture of the unsaturated dicarboxylic anhydride monomer and the solvent.

6. The method of claim 1, the initiator being at least one organic peroxide having at least two functional groups selected from a group consisting of 1,1-di(t-butylperoxy)3,3,5-trimethylcyclohexane, 1,1-di(t-butylperoxy)cyclohexane, 2,2-bis(t-butylperoxy)butane, 2,2,4-trimethylpentyl-2-hydroperoxide, 2,5-dimethyl-2,5-bis(t-butylperoxy)hexane, 2,5-dimethyl-2,5-di(benzoylperoxy)hexane, 1,1-di(t-amylperoxy)cyclohexane, 2,2-bis(4,4-di-t-butylperoxycyclohexyl)propane, ethyl-3,3-di(t-amylperoxy)butyrate, ethyl-3,3-di(t-butylperoxy)butyrate, 1,1-bis(t-butylperoxy)-3,3,5-trimethylcyclohexane and t-butylperoxy-3,5,5-trimethylhexanoate.

7. The method of claim 1, the initiator being used in 0.01-0.1 wt % per 100 wt % of the mixture of the aromatic vinyl monomer and the vinyl cyanide monomer plus the mixture of the unsaturated dicarboxylic anhydride monomer and the solvent.

8. The method of claim 1, the chain transfer agent being at least one selected from a group consisting of t-dodecylmercaptan, n-octylmercaptan and α-methylstyrene dimer.

9. The method of claim 1, the chain transfer agent being used in 0.01-0.5 wt % per 100 wt % of the mixture of the aromatic vinyl monomer and the vinyl cyanide monomer plus the mixture of the unsaturated dicarboxylic anhydride monomer and the solvent.

10. The method of claim 1, the unsaturated dicarboxylic anhydride monomer being at least one selected from a group consisting of maleic anhydride, citraconic anhydride, dimethylmaleic anhydride and phenylmaleic anhydride.

11. The method of claim 1, the unsaturated dicarboxylic anhydride monomer being used in 5-25 wt % per 100 wt % of the mixture of the aromatic vinyl monomer and the vinyl cyanide monomer plus the mixture of the unsaturated dicarboxylic anhydride monomer and the solvent.

12. The method of claim 1, the solvent being at least one ketone selected from a group consisting of methyl ethyl ketone, cyclohexanone, methyl isobutyl ketone and acetone.

13. The method of claim 1, the solvent being used in 30-60 wt % per 100 wt % of the mixture of the aromatic vinyl monomer and the vinyl cyanide monomer plus the mixture of the unsaturated dicarboxylic anhydride monomer and the solvent.

14. The method of claim 1, the copolymerization step being performed at 90-140° C. and residence time inside the reactor being 2-6 hours.

15. The method of claim 1, the primary amine being at least one selected from a group consisting of methylamine, ethylamine, propylamine, butylamine, hexylamine, cyclohexylamine, decylamine, aniline, toluidine, chlorophenylamine and bromophenylamine.

16. The method of claim 1, the primary amine being used in 0.5-1.5 moles per 1 mole of the unsaturated dicarboxylic acid anhydride.

17. The method of claim 1, the imide substitution step being performed at 130-180° C. and residence time inside the reactor being 1.5-4 hours.

18. An imide substituted copolymer resin prepared by a method of claim 1.
